(19) United States
(12) Patent Application Publication
(10) Pub. No.: US 2002/0063935 A1
(43) Pub. Date: May 30, 2002

(54) Optical transmission systems including upconverter apparatuses and methods

(76) Inventors: Alistair J. Price, Columbia, MD (US); Derek W. Meeker, Columbia, MD (US)

Correspondence Address: CORVIS CORPORATION, INTELLECTUAL PROPERTY DEPARTMENT, 7015 ALBERT EINSTEIN DRIVE, COLUMBIA, MD, 210469400

(21) Appl. No.: 09/798,011

(22) Filed: Mar. 2, 2001

Related U.S. Application Data
(60) Provisional application No. 60/186,908, filed on Mar. 3, 2000.

(51) Int. Cl. H04B 10/00; H04B 10/04

(52) U.S. Cl. 359/180; 359/161

(57) ABSTRACT

Apparatus, systems, and methods for use with optical transmitters and optical upconverters, including one or more bias circuits to adjust operating parameters of the apparatus, system or device. One embodiment of the bias circuit reduces power at an optical output to suppress an optical carrier, to extinguish sidebands, or to adjust other operational parameters. Another embodiment of the bias circuit reduces specific components of an optical output signal which correspond to an electrical oscillator at an input of the upconverter. Bias circuits can be operated simultaneously or separately in different time periods.

### CROSS-REFERENCE TO RELATED APPLICATIONS

This application claims priority from U.S. Provisional application No. 60/186,908, filed Mar. 3, 2000.

### STATEMENT REGARDING FEDERALLY SPONSORED RESEARCH OR DEVELOPMENT

Not Applicable

### BACKGROUND OF THE INVENTION

The present invention is directed generally to the transmission of information in communication systems. More particularly, the invention relates to transmitting information via optical signals using optical upconverters and using bias circuits to optimize components and devices.

The development of digital technology provided resources to store and process vast amounts of information. While this development greatly increased information processing capabilities, it was soon recognized that in order to make effective use of information resources, it was necessary to interconnect and allow communication between information resources. Efficient access to information resources requires the continued development of information transmission systems to facilitate the sharing of information between resources.

The continued advances in information storage and processing technology has fueled a corresponding advance in information transmission technology. Information transmission technology is directed toward providing high speed, high capacity connections between information resources. One effort to achieve higher transmission capacities has focused on the development of optical transmission systems for use in conjunction with high speed electronic transmission systems. Optical transmission systems generally employ optical fiber networks to provide high capacity, low error rate transmission of information over long distances at a relatively low cost.

The transmission of information over fiber optic networks is performed by imparting the information in some manner to a lightwave carrier by varying the characteristics of the lightwave. The lightwave is launched into the optical fiber in the network to a receiver at a destination for the information. At the receiver, a photodetector is used to detect the lightwave variations and convert the information carried by the variations into electrical form.

In most optical transmission systems, the information is imparted by using the information data stream to either modulate a lightwave source to produce a modulated lightwave or to modulate the lightwave after it is emitted from the light source. The former modulation technique is known as “direct modulation”, whereas the latter is known as “external modulation”, i.e., external to the lightwave source. External modulation is more often used for higher speed transmission systems, because the high speed direct modulation of a source often causes undesirable variations in the wavelength of the source. The wavelength variations, known as chirp, can result in transmission and detection errors in an optical system.

Data streams can be modulated onto the lightwave using a number of different schemes. The two most common schemes are return to zero (RZ) and non-return to zero (NRZ). In RZ modulation, the modulation of each bit of information begins and ends at the same modulation level, i.e., zero, as shown in FIG. 1(a). In NRZ schemes, the modulation level is not returned to a base modulation level, i.e., zero, at the end of a bit, but is directly adjusted to a level necessary to modulate the next information bit as shown in FIG. 1(b). Other modulation schemes, such as duobinary and PSK, encode the data in a waveform, such as in FIG. 1(c), prior to modulation onto a carrier.

In many systems, the information data stream is modulated onto the lightwave at a carrier wavelength, λ_{c}, (FIG. 2(a)) to produce an optical signal carrying data at the carrier wavelength, similar to that shown in FIG. 2(b). The modulation of the carrier wavelength also produces symmetric lobes, or sidebands, that broaden the overall bandwidth of the optical signal. The bandwidth of an optical signal determines how closely spaced successive optical signals can be spaced within a range of wavelengths.

Alternatively, the information can be modulated onto a wavelength proximate to the carrier wavelength using subcarrier modulation (“SCM”). SCM techniques, such as those described in U.S. Pat. Nos. 4,989,200, 5,432,632, and 5,596,436, generally produce a modulated optical signal in the form of two mirror image sidebands at wavelengths symmetrically disposed around the carrier wavelength. Generally, only one of the mirror images is required to carry the signal and the other image is a source of signal noise that also consumes wavelength bandwidth that would normally be available to carry information. Similarly, the carrier wavelength, which does not carry the information, can be a source of noise that interferes with the subcarrier signal. Modified SCM techniques have been developed to eliminate one of the mirror images and the carrier wavelength, such as described in U.S. Pat. Nos. 5,101,450 and 5,301,058.

Initially, single wavelength lightwave carriers were spatially separated by placing each carrier on a different fiber to provide space division multiplexing (“SDM”) of the information in optical systems. As the demand for capacity grew, increasing numbers of information data streams were spaced in time, or time division multiplexed (“TDM”), on the single wavelength carrier in the SDM system as a means to provide additional capacity. The continued growth in transmission capacity has spawned the transmission of multiple wavelength carriers on a single fiber using wavelength division multiplexing (“WDM”). In WDM systems, further increases in transmission capacity can be achieved not only by increasing the transmission rate of the information via each wavelength, but also by increasing the number of wavelengths, or channel count, in the system.

There are two general options for increasing the channel count in WDM systems. The first option is to widen the transmission bandwidth to add more channels at current channel spacings. The second option is to decrease the spacing between the channels to provide a greater number of channels within a given transmission bandwidth. The first option currently provides only limited benefit, because most optical systems use erbium doped fiber amplifiers (“EDFAs”) to amplify the optical signal during transmission. EDFAs have a limited bandwidth of operation and suffer from nonlinear amplifier characteristics within the bandwidth. Difficulties with the second option include controlling optical sources that are closely spaced to prevent interference from wavelength drift and nonlinear interactions between the signals.

A further difficulty in WDM systems is that chromatic dispersion, which results from differences in the speed at which different wavelengths travel in optical fiber, can also degrade the optical signal. Chromatic dispersion is generally controlled in a system using one or more of three techniques. One technique to offset the dispersion of the different wavelengths in the transmission fiber through the use of optical components such as Bragg gratings or arrayed waveguides that vary the relative optical paths of the wavelengths. Another technique is to intersperse different types of fibers that have opposite dispersion characteristics to that of the transmission fiber. A third technique is to attempt to offset the dispersion by prechirping the frequency or modulating the phase of the laser or lightwave in addition to modulating the data onto the lightwave. For example, see U.S. Pat. Nos. 5,555,118, 5,778,128, 5,781,673 or 5,787,211. These techniques require that additional components be added to the system and/or the use of specialty optical fiber that has to be specifically tailored to each length of transmission fiber in the system.

New fiber designs have been developed that substantially reduce the chromatic dispersion of WDM signals during transmission in the 1550 nm wavelength range. However, the decreased dispersion of the optical signal allows for increased nonlinear interaction, such as four wave mixing, to occur between the wavelengths that increases signal degradation. The effect of lower dispersion on nonlinear signal degradation becomes more pronounced at increased bit transmission rates.

Modern communications systems, some aspects of which are discussed above, are capable of at very high performance. In order to do so, however, those systems require high tolerances and performance of their components. Unfortunately, manufacturing variations, as well as other factors, cause significant operational variations in components. As a result, proper operation of modern systems requires that the components and systems be biased in some manner to compensate for the system's or component's particular variations. Such calibration or biasing is often very difficult and time consuming.

The many difficulties associated with increasing the number of wavelength channels in WDM systems, as well as increasing the transmission bit rate have slowed the continued advance in communications transmission capacity. In view of these difficulties, there is a clear need for transmission techniques and systems that provide for higher capacity, longer distance optical communication systems.

### BRIEF SUMMARY OF THE INVENTION

The apparatuses, systems, and methods of the present invention address the above need for improved optical transmission systems and apparatuses. The present invention can be employed, for example, in multi-dimensional optical networks, point to point optical networks, or other devices or systems which can benefit from the improved performance afforded by the present invention.

One embodiment of the present invention includes one or more bias circuits to adjust operating parameters of the apparatus, system or device. The present invention can include multiple bias circuits in a single device, and in the present invention multiple bias devices can be operated simultaneously or individually.

One embodiment of the bias circuit adjusts a bias to drive power at an optical output to a desired level. Another embodiment of the bias circuit adjusts a bias to reduces specific components of an optical output signal which correspond to an electrical oscillator at an input of the upconverter or transmitter. The present invention can be used, for example, to suppress an optical carrier and/or to extinguish sidebands, or to adjust other operational parameters.

The present invention can compensate for operational variations and, therefore, allow for more efficient operation of the transmitter. Those and other embodiments of the present invention will be described from the following detailed description. The present invention addresses the needs described above in the description of the background of the invention by providing improved apparatuses and methods. These advantages and others will become apparent from the following detailed description.

### BRIEF DESCRIPTION OF THE DRAWINGS

Embodiments of the present invention will now be described, by way of example only, with reference to the accompanying drawings, wherein:

FIGS. 1(a-c) show a typical baseband return to zero (“RZ”) and non-return to zero (“NRZ”) data signal;

FIGS. 2(a-c) show the intensity versus wavelength plots for an unmodulated optical carrier, modulated carrier, and modulated subcarriers of the carrier;

FIGS. 3 and 3a shows an optical system embodiments which can utilize the present invention;

FIG. 4 shows a portion of a transmitter according to one embodiment of the present invention;

FIG. 5 shows one embodiment of an optical upconverter according to the present invention;

FIGS. 6, 7, 9, and 10 show exemplary bias input and output versus time curves; and,

FIGS. 8, 11, 12, 12a, and 20 show exemplary bias set point apparatuses according to the present invention;

FIGS. 13-15 show exemplary signal graphs in the frequency domain at several points in the apparatus illustrated in FIG. 12; and

FIGS. 16-19 show various power versus bias curves associated with the apparatus of FIG. 20.

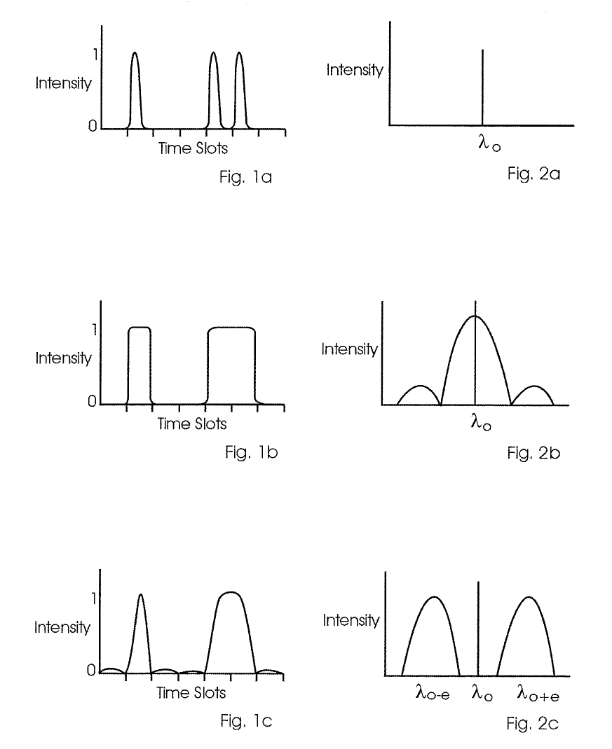

### DETAILED DESCRIPTION OF THE INVENTION

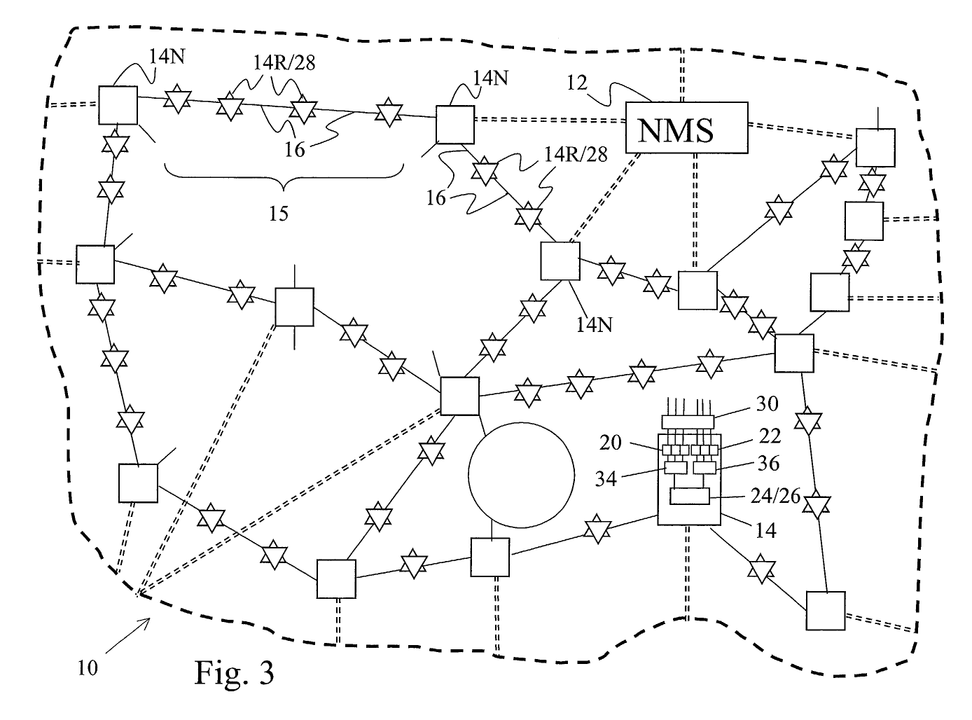

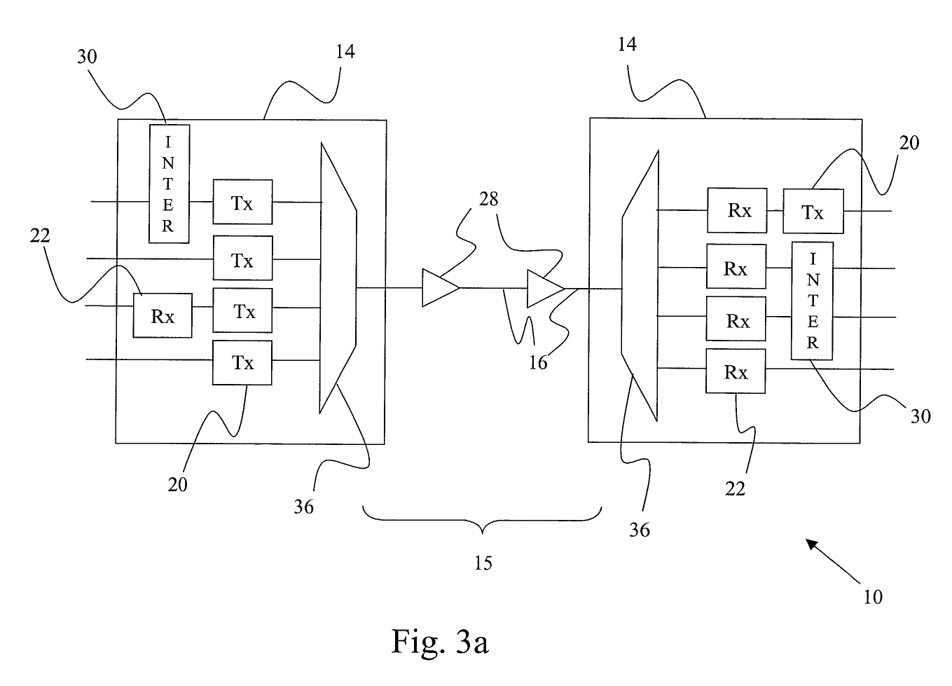

FIG. 3 shows an optical system 10 of the present invention, which includes a network management system (“NMS”) 12 to manage, configure and control network elements 14 in the system 10. The system 10 is illustrated as a multi-dimensional network, although advantages of the present invention may be realized with other system 10 configurations, such as a point to point configuration shown in FIG. 3a. Also, the system 10 can employ various architectures, such as mesh or rings, depending upon the network requirements. Various transmission schemes, such as space, time, code, frequency, and/or wavelength division multiplexing, etc. can be used in the system 10.

The NMS 12 can include multiple management layers that can be directly and indirectly connected to the network elements 14. In the illustrated embodiment, the network elements 14 can be characterized as network element nodes 14N, which are directly connected to the NMS 12, and remote network elements 14R, which communicate to the NMS 12 indirectly via a network element node 14N. For example, the NMS 12 may be directly connected to some network elements 14 via a data communication network (shown in broken lines) and indirectly connected to other network elements 14 via the optical system 10. The data communication network can be a dedicated wide area network, a shared network, or a combination thereof. A wide area network utilizing a shared network can utilize, for example, dial-up connections to the network elements 14 through a public telephone system.

Various guided and unguided media, such as one or more optical fibers, can be used to interconnect the network elements 14 establishing links 15 between the network element nodes 14N and providing optical communication paths 16 through the system 10. The transmission media in each path 16 can carry one or more uni- or bi-directionally propagating optical signal channels, or wavelengths, depending upon the system 10. The optical signal channels in a particular path 16 can be treated individually or as a single group, or can be organized into and treated as two or more wavebands or spectral groups, each containing one or more optical signal channels.

The network elements 14 can include one or more signal processing devices including one or more of various optical and/or electrical components. The network elements 14 can perform network functions or processes, such as switching, routing, amplifying, multiplexing, and demultiplexing of optical signal channels. For example, network elements 14 can include transmitters 20, receivers 22, optical switches 24, add/drop multiplexers 26, amplifiers 28, and interfacial devices 30, as well as multiplexers, demultiplexers, filters, dispersion compensating devices, monitors, and the like.

The network elements 14 can include various combinations of optical switching devices 24, transmitters 20, and receivers 22, depending upon the desired functionality. For example, in WDM embodiments, the network element 14 can include one or more optical transmitters 20 and optical receivers 22 along with multiplexers, demultiplexers, and other associated components, as well as optical switching devices 24 or add/drop devices 26.

The optical transmitters 20 and optical receivers 22 are configured respectively to transmit and receive optical signals including one or more information carrying optical signal wavelengths, or channels, λᵢ via the communication paths 16. The transmitters 20 will generally include a narrow bandwidth laser optical source that provides an optical carrier. The transmitters 22 also can include other coherent narrow or broad band sources, such as sliced spectrum sources, fiber lasers, light emitting diodes, and other suitable incoherent optical sources, as appropriate.

The optical transmitter 20 can impart information to the optical carrier either by directly modulating the optical source or by externally modulating the optical carrier emitted by the source. Alternatively, the information can be imparted to an electrical carrier that can be upconverted onto an optical wavelength to produce the optical signal. Similarly, the optical receiver 22 can include various detection techniques, such coherent detection, optical filtering and direct detection, and combinations thereof. Tunable transmitters 20 and receivers 22 can be used to provide flexibility in the selection of wavelengths used in the system 10.

The optical amplifiers 28 can be deployed proximate to other optical components to provide gain to overcome component losses, as well as along the optical communication paths 16 to overcome fiber attenuation. The optical amplifiers 28 can include doped (e.g. erbium) and Raman fiber amplifiers that can be locally or remotely pumped with optical energy, as well as semiconductor amplifiers. The optical amplifiers 28 include one or more stage of concentrated/lumped amplifiers at discrete network element 14 and/or doped and Raman fiber amplifiers 28 distributed as part of the transmission fiber 16.

The interfacial devices 30 may include, for example, electrical and optical/electrical cross-connect switches, IP routers, ATM switches, etc., to provide interface flexibility within, and at the periphery of, the optical system 10. The interfacial devices 30 can be configured to receive, convert, and provide information in one or more various protocols, encoding schemes, and bit rates to the transmitters 20, and perform the converse function for the receivers 22. The interfacial devices 30 also can be used to provide protection switching in various nodes 14 depending upon the configuration.

Optical combiners 34 can be used to combine the multiple signal channels into WDM optical signals for the transmitters 20. Likewise, optical distributors 36 can be provided to distribute the optical signal to the receivers 22. The optical combiners 34 and distributors 36 can include various multi-port devices, such as wavelength selective and non-selective (“passive”), fiber and free space devices, and polarization sensitive devices. Other examples of multi-port devices include circulators, passive, WDM, and polarization couplers/splitters, dichroic devices, prisms, diffraction gratings, arrayed waveguides, etc. The multi-port devices can be used alone or in various combinations with various tunable or fixed wavelength transmissive or reflective, narrow or broad band filters, such as Bragg gratings, Fabry-Perot and dichroic filters, etc. in the optical combiners 34 and distributors 36. Furthermore, the combiners 34 and distributors 36 can include one or more stages incorporating various multi-port device and filter combinations to multiplex, demultiplex, and/or broadcast signal wavelengths λᵢ in the optical systems 10.

FIG. 3a shows a system 10 including a link 15 of four network elements 14. That system 10 may be all or part of a point to point system 10, or it may be part of a multi-dimensional system 10 like the example illustrated in FIG. 3. One or more of the network elements 14 can be connected directly to the network management system 12. If the system 10 illustrated in FIG. 3a is part of a larger system 10, then as few as none of the network elements 14 can be connected to the network management system 12 and all of the network elements 14 can still be indirectly connected to the NMS 12 via another network element, which is not shown.

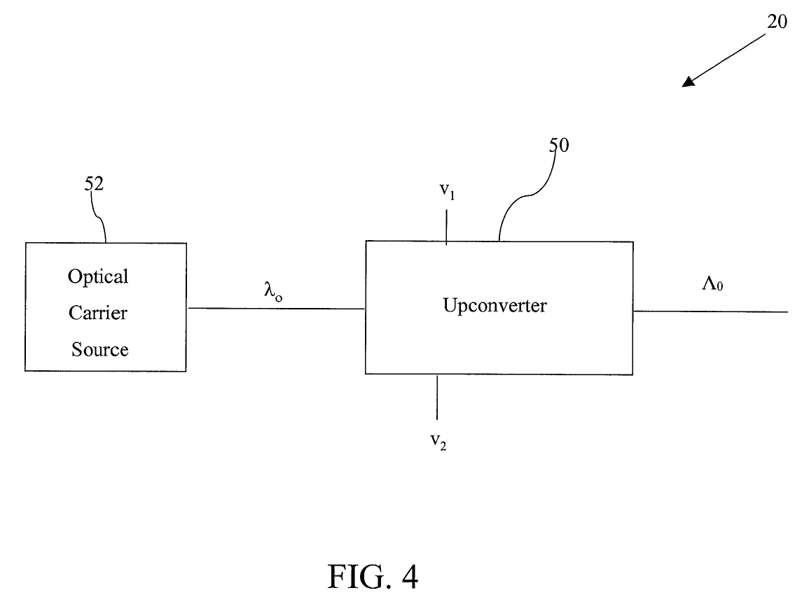

FIG. 4 shows one embodiment of part of a transmitter 18, in which an optical upconverter 50 receives an optical carrier λ₀ from an optical carrier source 52, and also receive one or more electrical data signals v₁, v₂ which are upconverted onto the optical carrier λ₀ to form an output signal Λ₀. In the illustrated embodiment, the output signal Λ₀ includes one or more sidebands, with or without a suppressed carrier. In other embodiments, the output signal Λ₀ can take other forms, such as an amplitude modulated signal at the carrier frequency.

The present invention will generally be described in terms of a transmitter 18 and, more specifically, of an optical upconverter 50. However, the present invention can also be embodied in other systems and devices, such as receivers and other parts or variants thereof which can benefit from the present invention. For example, the present invention can be utilized in a system or apparatus which does not include an upconverter 50, but rather provides, for example, amplitude modulation.

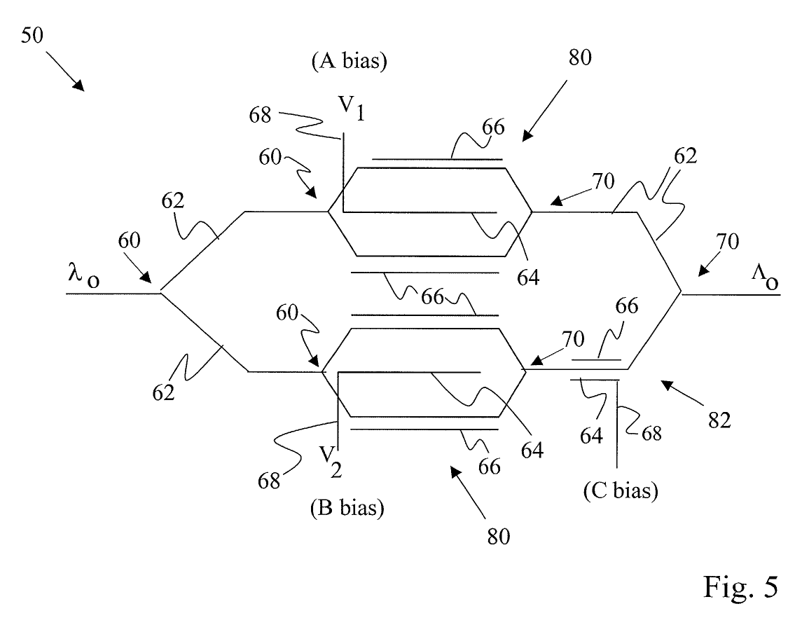

FIG. 5 shows one embodiment of the upconverter 50, in the form of a double parallel Mach-Zehnder arrangement. In that embodiment, the upconverter 50 includes an optical splitters 60 to split the optical carrier into several split optical carriers, optical paths 62 to carry the split optical signals, Mach-Zehnder modulators 80 to upconvert data signals v₁, v₂ onto the split optical carriers, a phase shifter 82 to adjust the relative phase of the upconverted optical signals, and optical combiners 70 to combine the signals.

The splitters 60 split the optical carrier to form several split optical carriers. One splitter 60 splits the optical carrier into two optical paths 62. Two other optical splitters 60 on the optical paths 62 subsequently split each split optical carriers, resulting in a total of four split optical carriers. Typically, the splitters 60 split the optical signals equally to each path 62. In another embodiment, a single 1:4 optical splitter 60 can be used.

The Mach-Zehnders 80 include input and ground electrodes 64, 66 and an electro-optical material 67, such as Lithium Niobate (LiNbO₃), located in the optical paths 62 and which, in combination with the electrodes 64, 66, can affect one or more characteristics of the optical carrier.

The phase shifter 82 controls the relative phase of the upconverted optical signals. The phase shifter can be embodied in a manner similar to that of the Mach-Zehnders 80, such as by using an electro-optic material and electrodes. The phase shifter 82 can be embodied, for example, on only one of the optical paths 62, either before or after the Mach-Zehnders 80, or it can be embodied on more than one path. For example, the phase shifter 82 can operate on two parallel optical paths 62, and adjust the relative phase difference by effecting a positive phase shift in one path and a corresponding negative phase shift in the other path.

The combiners 70 mirror the splitters 62 and recombine the split optical signal into a single, upconverted optical signal Λ₀ including the data from both electrical input signals v₁, v₂.

The upconverter 50 receive electrical input signals v₁ and v₂ at input electrodes 64 via input terminals 68. The input electrodes 64 produce electromagnetic fields which affect the electro-optic material 67 and cause variations in one or more characteristics of the split optical carrier, such as by changing the index of refraction of the electrooptic material 67 through which the split optical carrier travels. As a result, the electrical input signals are upconverted onto the split optical carriers to form upconverted optical signals.

The upconverter 50 also receives an electrical phase signal at phase shifter's electrode 64 via a phase input 68, which causes variations in one or more characteristics of the upconverted optical carriers, which can provide for a desired phase difference between the optical signals from the Mach-Zehnders 80. For example, a ninety degree phase difference can be maintained between the optical signals.

In the illustrated embodiment, for example, the upconverter 50 can be controlled to produce upconverted optical signal channels at frequencies other than the optical carrier frequency, and to suppress the carrier λ₀ provided by the optical source 52. However, the particular bias necessary to achieve a desired result will vary based on many factors, such as manufacturing variations, temperature variations, etc.

To achieve an upconverted optical signal with two single side bands and a suppressed carrier, for example, the Mach-Zehnder inputs of the upconverter 50 must be adjusted to suppress the optical carrier, and the phase shifter 82 must maintain a ninety (90) degree relative phase shift between upconverted optical signals. The desired operation of the upconverter 50 can be achieved by properly biasing the upconverter 50. The bias applied to the Mach-Zehnders 80 and phase shifter 82 will be referred to as bias A, B, and C, respectively.

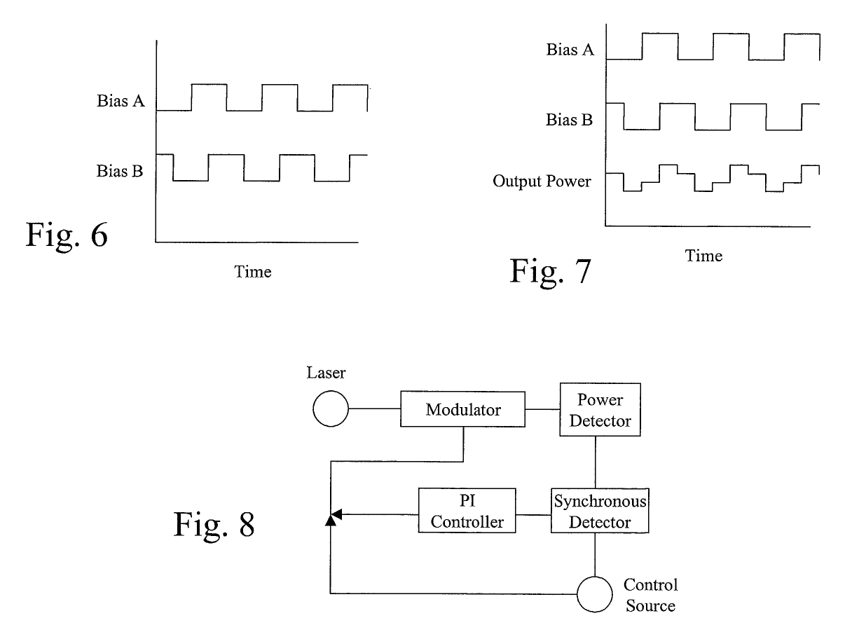

FIGS. 6-8 illustrate one method and apparatuses for adjusting upconverter 50 according to the present invention. The A and B biases are controlled so that the modulator arms are biased at extinction. The C bias is controlled so that the signals from the two modulator arms are recombined in quadrature. The biasing scheme can be implemented using various methods of which several exemplary methods are descried herein.

In one method, a bias signal having a bias frequency and a DC component is applied to the A bias, while the optical carrier λ₀ is provided at the input of the upconverter 50. The bias signal is varied and the output optical power is monitored to identify the bias set point. When the frequency component of the bias signal being applied to the carrier input signal is minimized on the output carrier, the A bias is at the correct point. The same bias signal, phase shifted by 90 degrees (FIG. 6), is applied to the B bias. Similarly, when the frequency component of the bias signal being applied to the optical carrier is minimized on the output, the B bias is at the correct point.

No extra signals are required to control the C bias. When the control signals are properly applied to the A and B biases, the output power will have a component which is similar to the control signal, but at twice the frequency. By minimizing the component at twice the frequency, the C bias is controlled to the correct point.

In one method, a square wave is the control signal applied to the A and B biases. The square waves for the A and B biases are shifted in phase by 90 degrees. To detect the component from the A bias, the output power is fed to a synchronous detector. The detector can be driven by the square wave that drives the A bias. Since the B bias is phase shifted by 90 degrees, the signal due to the B bias square wave will switch from one state to another during one half cycle of the A bias square wave. When driven by the square wave for the A bias, the detector detects the contribution from both states (FIG. 7) of the B bias square wave during either half cycle. A similar component from the B bias square wave is detected during the other half cycle of the A bias square wave. The detector effectively subtracts the signals from each half cycle. The common mode signal from the B bias square wave is removed, making the A bias measurement somewhat independent of the B bias state. The control of the B bias is similarly unaffected by the state of the A bias. The output of the detectors can be filtered to remove noise and any unwanted frequency components. The output of the detector can provide feedback to a proportional integral controller (FIG. 8) which adjusts a DC bias to the square wave of each bias. When the control loop is properly set up, the A and B biases will be adjusted so that their respective modulators are biased to extinction.

To control the C bias, the output power signal is detected by a synchronous detector driven by a square wave of a frequency double the frequency of the square waves driving the A and B biases. Similar to the A and B biases, the output of the detector is filtered and used as feedback in a control loop. Another proportional integral control loop is used to maintain the C bias at the point required to align the signals from the two arms of the modulator in quadrature.

The generation of the square waves can be done from a common stable source. The source square wave is at twice the frequency of the square wave desired to drive the A and B biases. The source square wave is also used as the input to the synchronous detector used to control the C bias. The A and B bias square waves can be created through a flip flop or other divide by two digital circuit. The flip flop that creates the A bias square wave can be clocked by the rising edge of the common source. The flip flop that creates the B bias square wave can be clocked by the falling edge of the common source. If the duty cycle of the common source is 50% the A and B square waves are out of phase by 90 degrees. It is assumed that the circuitry is set up such that the duty cycle of any signal either used in driving the modulator biases, or used in the detection of the biases has a 50% duty cycle. The control signals are not required to be square waves. For example, the control signals may be sine waves.

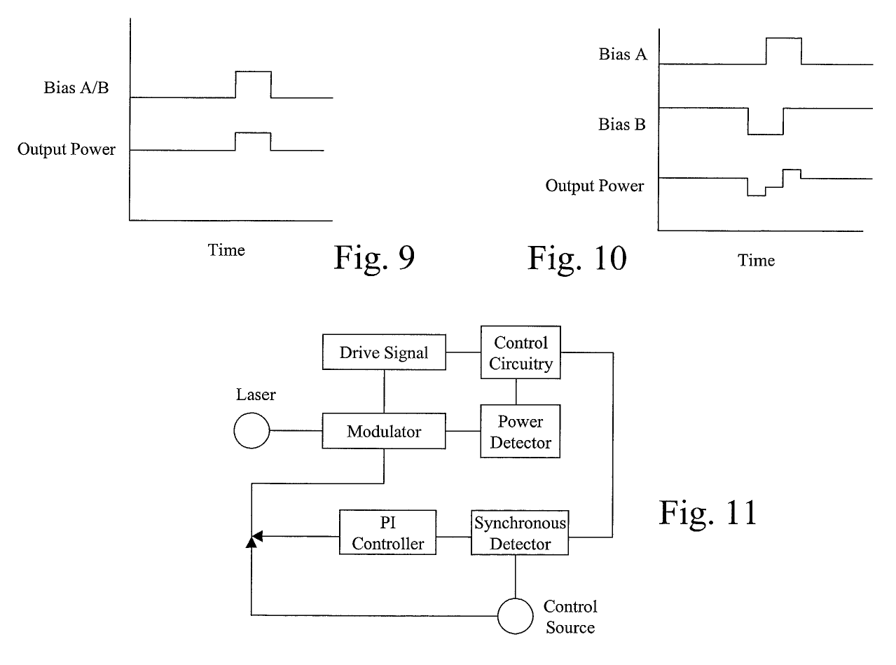

FIGS. 9-11 illustrate another embodiment of adjusting the modulators according to the present invention. That embodiment does not involve synchronous detection, and the biases are not controlled simultaneously. To control the A bias, the output power is measured at two bias points. One of the bias points can be the current bias point, but that is not a requirement. The required direction for a shift in the bias can be determined by measuring the difference in power between the two bias points (FIG. 9). After the direction is determined, the bias can then be moved in the correct direction. This method can be iterated until the bias reaches a point where the amount of shifts in one direction is roughly equal to the amount of shifts in the opposite direction. In other words, the method can be iterated until the power minimum is reached. This state corresponds to the minimization of output power due to that bias. While the minimization of power is not always an indication of the desired bias point, when all three biases are at or near the correct location, the minimum power point will be the correct location. The A and B bias adjustment are generally performed serially to minimize interference between the two biases.

In various embodiments, the C bias is controlled using four bias states to determine the direction of the shift of the C bias (FIG. 10). The four states are as follows: State one, bias A low, bias B low. State two, bias A low, bias B high. State three, bias A high, bias B high. State four, bias A high, bias B low. The direction is obtained from the equation state one+state three−state two−state four. The bias is then stepped in the proper direction until the number of shifts in one direction is roughly equal to the number of shifts in the opposite direction. The bias states used in the control of the C bias occur after the bias states used to control the A and B biases. The occurrences of the control states of the biases in this algorithm do not need to be in any specific order, nor do they need to repeat with the same frequency.

In one application of the bias control, the output power of the modulator is controlled by an external control loop to be a constant value. It is easy to realize that without variations in output power, the output power cannot be used to control the biases. In this application, the signal used to monitor the control signals on the biases is the error signal of the control loop (FIG. 11). A signal independent of the control signals is applied to the modulator. The amplitude of that signal is used to control the output power. When the biases change, the amplitude required to maintain the same output power from the modulator changes. Therefore, we can use the amplitude or the control signal of the amplitude in place of the output power to control the biases of the modulator.

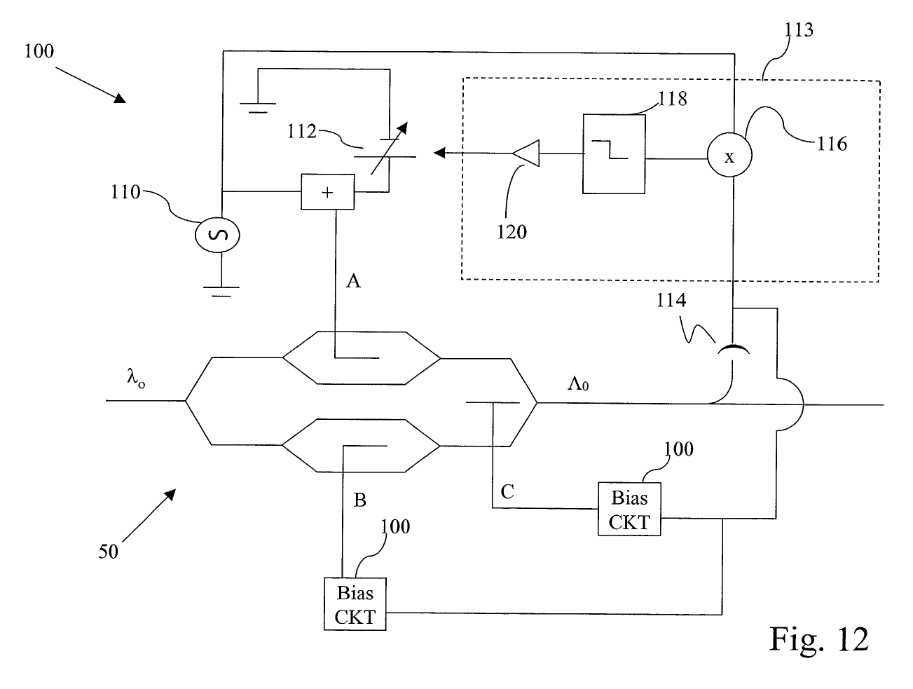

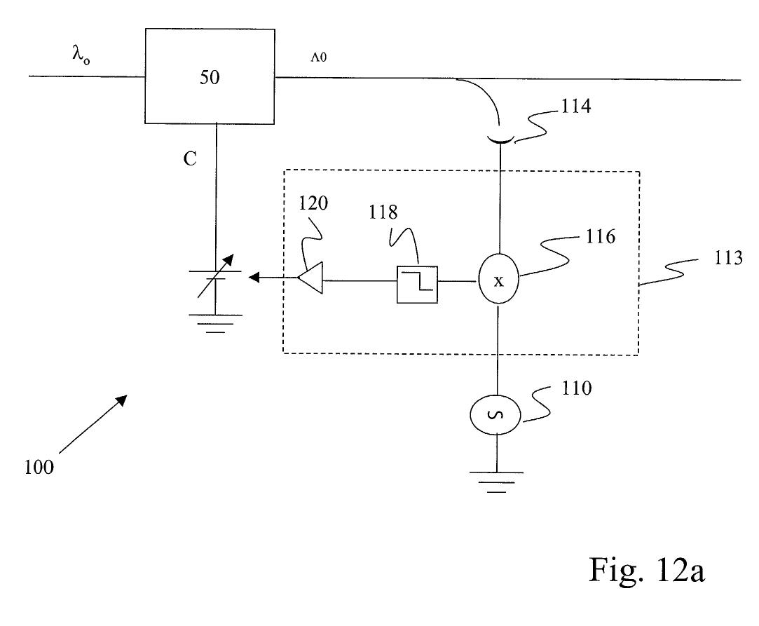

FIG. 12 shows another embodiment of the present invention. In that embodiment, the upconverter 50 is connected to a bias circuits 100 for adjusting the A, B, and C biases. The bias circuit 100 includes an electrical oscillator 110 connected to the input electrode 64 of the upconverter 50, a variable DC voltage source 112 connected to the input electrode 64 of the upconverter 50, and a feedback circuit 113 for providing a feedback signal to the variable DC voltage source 112.

The bias circuit 100 will be described in terms of discrete components. However, the bias circuit, and parts thereof, can also be embodied in other forms, such as one or more controllers, including ASICs and other form of integrated signal processors and controllers. The controller can provide control signals to the bias circuits loo to affect the steps described herein. For example, the bias circuits 100 can be replaced with one or more controllers which can monitor the output of the upconverter 50, perform the necessary signal processing, such as digital to analog and analog to digital conversions, filtering, gain, etc., and provide the necessary bias signal, both DC and AC to the upconverter 50. The controller can also include memory for storing data and instructions, such as for performing the methods described herein. Furthermore, the bias circuit 100 will be described in terms of specific embodiments, although it can be embodied in variations of the illustrated embodiments and in other forms not discussed herein.

The electrical oscillator 110 generates a periodic electrical signal on which, for example, input signal v₁ can be carried in order to upconvert input signal v₁ onto the optical carrier. When setting the bias voltage for the upconverter 50, however, the oscillator 110 typically will not used to carry signals.

The variable DC voltage source 112 applies a bias to the upconverter 50. The bias circuit 100 adjusts the DC voltage source 112 until a desired bias is achieved. The DC voltage source 112 can be started, for example, at zero volts, or it can be started at another voltage near which a final bias voltage is expected. The variable DC voltage source 112 and the electrical oscillator 110 can be combined, for example, with an adder.

The feedback circuit 113 provides a signal indicative of one or more characteristics of the upconverter 50. In the illustrated embodiments, the feedback circuit 113 provides signals indicative of the optical output of the upconverter 50, although the feedback circuit 113 can also provide feedback signals indicative, for example, of a signal or characteristic inside the upconverter 50, or from another device. The feedback circuit will be described in terms of several embodiments, although the feedback circuit 113 can be embodied in any form which provides the requisite feedback signal.

In the illustrated embodiment, the feedback circuit 113 includes a photodetector 114, a multiplier 116, a low pass filter 118, and an amplifier 120. The feedback circuit provides a feedback signal to the variable DC voltage source 112 such that the variable DC voltage source 112 will be adjusted to minimize optical signal components having the frequency of the oscillator 110.

The photodetector 114 in the illustrated embodiment converts the optical signal to an electrical signal. The photodetector 114 generates an electrical signal with frequency components that are formed by combining the various frequency components of the optical signal based on the relative frequency spacing between those optical signal components.

The multiplier 116 combines the electrical signal indicative of the output of the upconverter 50 with the signal from the oscillator 110, and produces an output signal which includes, among other signals, a DC signal indicative of the portion of the optical signal having the frequency of the oscillator 110.

The filter 118 can be used to remove unwanted signals, and the amplifier 120 can be used to impart a gain, either positive or negative, to the signal so that the appropriate level of feedback is received by the variable DC source 112.

The bias circuits 100 for the B bias is analogous to bias circuit 100 for the A bias described above. The electrical oscillators 110 in both bias circuits 100 are typically operated at the same frequency and amplitude, but with a ninety degree relative phase shift. For convenience, the respective variable DC voltage sources 112 can be started at the same voltage, or they can be started at different voltages.

FIG. 12a shows one embodiment of the bias circuit 100 for the phase input C according to the present invention. That bias circuit 100 is analogous to the bias circuits 100 for the first and second inputs A, B of the upconverter 50, with some exceptions. For example, the electrical oscillator 110 operates at twice the frequency of the oscillators 110 for biases A and B, and is not combined with the variable DC voltage source 112. Also, the feedback circuit 113 adjusts the variable DC voltage source 112 to minimize the frequency of the phase shifter's 82 oscillator 110 in order to obtain a ninety degree relative phase shift between the signals of the upconverted signals.

All of the bias circuits can operate simultaneously to adjust their respective bias voltages. The bias circuits for A and B can operate simultaneously because the ninety degree phase shift between the respective oscillators 110 allows each bias circuit 100 to distinguish between its effect on the output of the upconverter 50 and the other bias circuit's 100 effect on the output of the upconverter 50. The phase shifter 82 is not affected by the other bias circuits because it is making adjustments based on a different signal frequency.

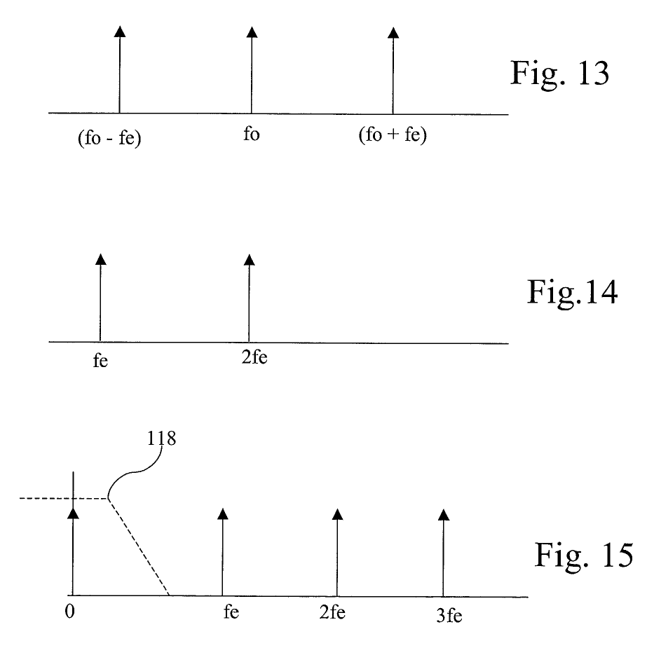

FIGS. 13-15 show examples of signals in the frequency domain at various locations in the bias circuit 100. FIG. 13 shows one example of an optical signal, in the frequency domain, at the output of the upconverter 50. That figure shows the optical carrier at frequency fₒ and two subcarriers, one at frequency (fₒ+fₑ), and one at frequency (fₒ−fₑ), wherein fₑ is the frequency of the electrical oscillator 110. Other signal components may also be generated, but they are typically not of interest for this discussion, and they can be ignored or eliminated, for example, by choosing a photodetector which lacks the sensitivity to detect them, or through the use of filters.

FIG. 14 shows the electrical signal at the output of the photodetector 114. As mentioned above, the electrical signal produced by the photodetector 114 is indicative of the corresponding optical signal. In the illustrated embodiment, the carrier fₒ combines with each of the subcarrier signals to produce an electrical signal at frequency fₑ, which is the frequency difference between them. The subcarriers also combine to produce an electrical signal having a frequency of 2 fₑ, which is the frequency difference between the subcarrier signals.

FIG. 15 shows the electrical signal at the output of the multiplier 116. The electrical signal indicative of the optical signal component at the frequency fₑ of the electrical oscillator 110 is now at a DC voltage. The other signals, which are not needed, can be removed, such as with the low pass filter 118 (illustrated figuratively as a broken line). If necessary, the signal can be amplified to provide the appropriate signal level to the variable DC voltage supply 112.

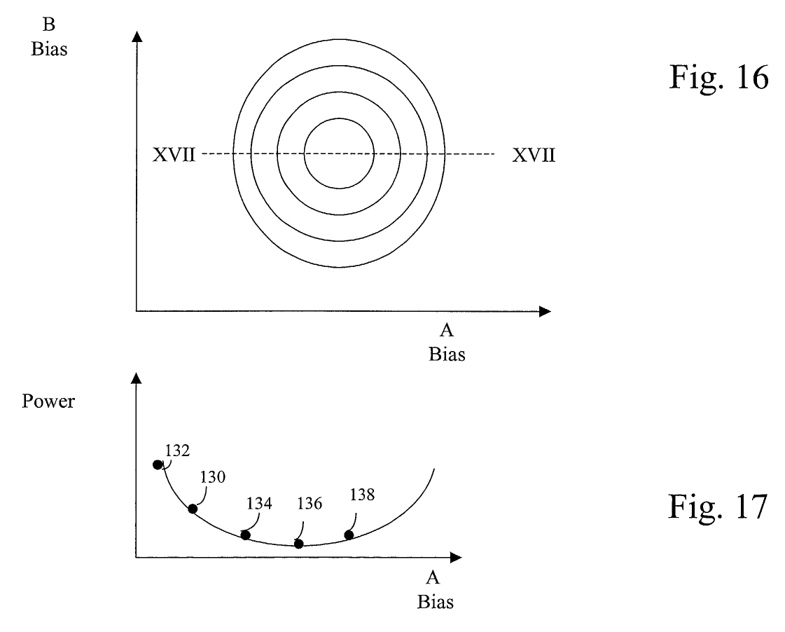

FIGS. 16-19 show another manner of adjusting the upconverter 50 according to the present invention. In that embodiment, the various biases are not adjusted simultaneously, but rather is done in an interleaved manner. For example, bias A is adjusted, then bias B is adjusted, bias C is adjusted, and then the process repeats until the all biases are properly adjusted. The order of adjustment can be varied, and every bias need not be adjusted the same number of times. For example, all of the biases can be adjusted one or more times, and then less than all of the biases can be adjusted one or more times.

FIG. 16 shows a graph of optical carrier power as a function of the A and B biases. Each concentric circle is an isopower, where the optical carrier power is equal along that circle. At the center of the concentric circles the optical carrier power is at a minimum, and it increases as the biases move away from the center setting.

FIG. 17 is a cross-sectional view of power versus the A bias setting along line XVII-XVII of FIG. 16. Because the precise power to bias curve for a given module, at a given time, is usually unknown, one method of setting the bias is to chose a starting point 130, and then to incrementally increase and/or decrease the DC bias voltage to one or more points 132, 134, such as is provided by the variable DC voltage source 112, and measure the resultant power of the optical signal. The direction in which the bias was changed, and the resultant change in power, generally indicates the amplitude and direction in which the bias must be changed in order to approach the power minimum 136. The process can be iterated until the minimum 136 is found. The bias circuits can operate separately, i.e., not simultaneously, to iteratively vary the bias voltage and measure the resultant power until each have found their respective minimum power settings.

In the illustrated example, the initial bias setting 130 can be decreased to point 132 and increased to point 134, and the powers measured. In that example, it is apparent that the bias setting at point 130 is not the minimum 136, and that the bias must be increased to approach the minimum 136. In the next iteration, the new bias setting is 134. Because the power at the previous bias setting 130 is known, only a single increased bias setting 136 need be measured. In the illustrated example, bias point 136 is the power minimum, but that is not necessarily apparent. In the next iteration bias point 136 becomes the new setting and another increased bias point 138 is measured. From bias point 138 it is apparent that bias point 136 is roughly at the power minimum. Further iterations, using smaller bias increments, can be performed to fine tune the bias setting.

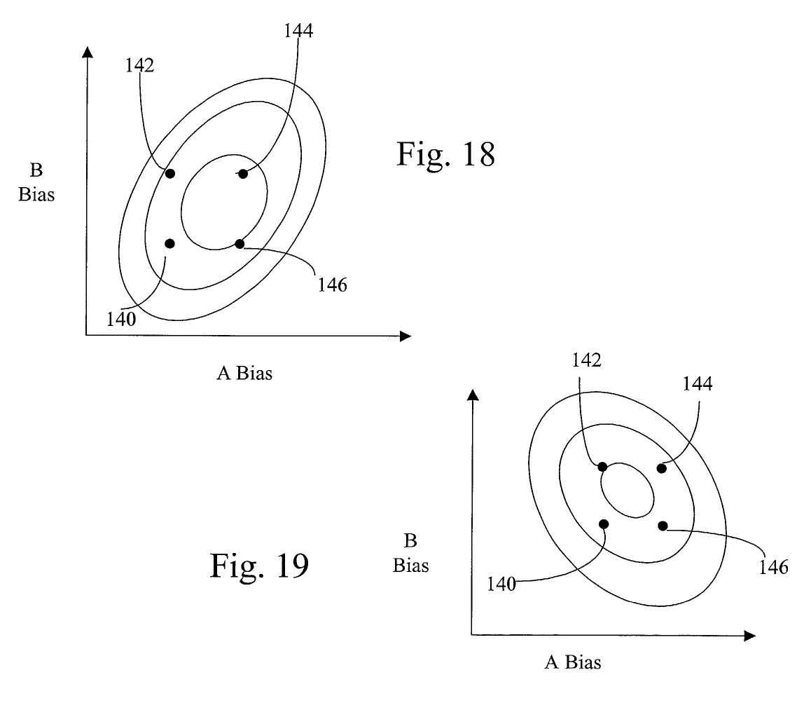

FIGS. 18 and 19 show the signal power to DC bias graph in cases where relative phase shift between the upconverted signals from the Mach-Zehnders 80 is more or less than ninety degrees. The bias error in the phase shifter 82 can be corrected by measuring and adjusting the optical carrier power in a manner analogous to that for biases A and B.

As discussed above with respect to FIG. 10, skew in the signal power to DC bias graph can be detected by measuring the signal power at various combinations bias settings. For example, the bias of the phase shifter 82 can tested by taking four power measurements. The power measurements are relative to the current bias settings, and are either increased or decreased by the same amount (“Δ”) relative to the current settings, as follows:

1. A−Δ, B−Δ;

2. A−Δ, B+Δ;

3. A+Δ, B+Δ; and

4. A+Δ, B−Δ.

Examples of the four measurements are shown in FIGS. 18 and 19 as bias points 140, 142, 144, and 146, respectively. From the power measurements at those four bias settings, an error factor can be calculated as follows:

E_{c}=(1+3)−(2+4).

The sign of the error factor E_{c} is indicative of the direction in which the DC bias voltage of the phase shifter must be changed, and the magnitude of the error factor E_{c} is indicative of the amount in which it must be changed.

The correction of the bias in the phase shifter 82 can be performed with the adjustments to the A and B biases, and each measurement and adjustment can take its turn, or the adjustment of the phase shifter 82 can occur before or after the A and B biases are adjusted.

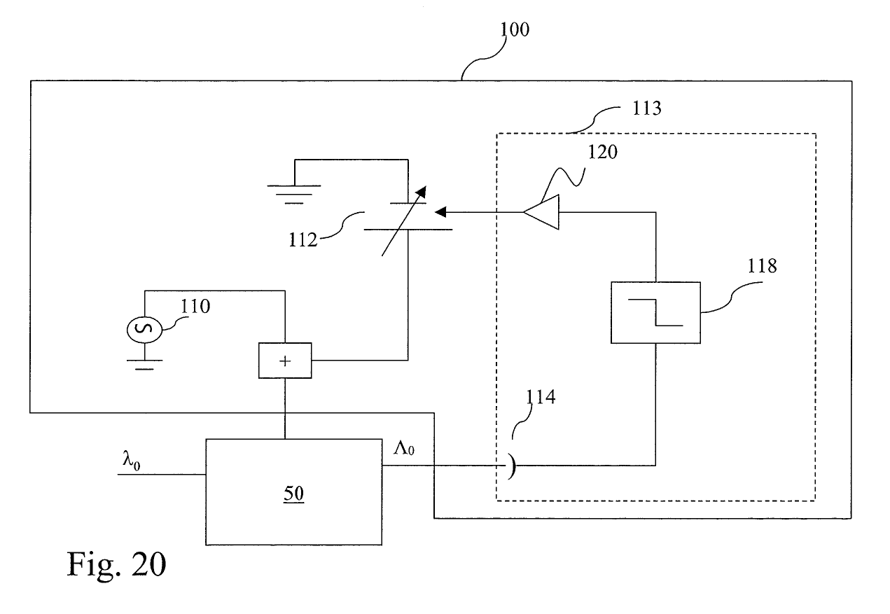

FIG. 20 shows one embodiment of a bias circuit 100 that can be used to perform the method described with respect to FIGS. 16-19. That embodiment of the bias circuit 100 measures output power from the upconverter 50 and generates a feedback signal to control the respective biases based on power at the output of the upconverter 50.

It will be appreciated that the present invention provides for improved optical systems and apparatuses. Those of ordinary skill in the art will further appreciate that numerous modifications and variations that can be made to specific aspects of the present invention without departing from the scope of the present invention. It is intended that the foregoing specification and the following claims cover such modifications and variations.

1. An optical transmitter, comprising:
an optical upconverter including a double parallel Mach-Zehnder and first and second electrical oscillators connected to first and second electrical inputs, respectively, of the double parallel Mach-Zehnder;
a first feedback circuit responsive to an optical output of the optical upconverter and providing a first feedback signal indicative of a signal component corresponding to an oscillation frequency of the first electrical oscillator;
a first variable DC voltage source responsive to the first feedback signal and providing a variable DC voltage bias to the first electrical input, wherein the variable DC voltage source responds to the first feedback signal to reduce the signal component corresponding to the oscillation frequency of the first electrical oscillator.

2. The optical transmitter of claim 1, further comprising:
a second feedback circuit responsive to an output of the optical upconverter and providing a second feedback signal indicative of a signal component corresponding to an oscillation frequency of the second electrical oscillator;
a second variable DC voltage source responsive to the second feedback signal and providing a variable DC voltage bias to the second electrical input, wherein the variable DC voltage source responds to the second feedback signal to reduce the signal component corresponding to the oscillation frequency of the second electrical oscillator.

3. The optical transmitter of claim 2, further comprising:
a third feedback circuit responsive to an output of the optical upconverter and providing a third feedback signal indicative of a signal component corresponding to an oscillation frequency twice that of the first electrical oscillator;
a third variable DC voltage source responsive to the third feedback signal and providing a variable DC voltage bias to an electrical phase input to the optical upconverter, wherein the variable DC voltage source responds to the third feedback signal to reduce the signal component corresponding to an oscillation frequency twice that of the first electrical oscillator.

4. The optical transmitter of claim 3, wherein the first, second, and third feedback circuits and the first, second, and third variable DC voltage sources are operated simultaneously and iteratively to adjust DC bias voltages to the first and second electrical inputs and to the phase input.

5. The optical transmitter of claim 4, wherein the DC bias voltages are adjusted to suppress an optical carrier at the optical output of the optical upconverter, and to provide at the optical output of the optical upconverter at least one single sideband optical signal at a frequency other than a frequency of the optical carrier.

6. An optical transmitter, comprising:
an optical upconverter including a double parallel Mach-Zehnder and first and second electrical oscillators connected to first and second electrical inputs, respectively, of the double parallel Mach-Zehnder;
a first feedback circuit responsive to an optical output of the optical upconverter and providing a first feedback signal indicative of power at the optical output of the optical upconverter;
a first variable DC voltage source responsive to the first feedback signal and providing a variable DC voltage bias to the first electrical input, wherein the variable DC voltage source responds to the first feedback signal to reduce the power at the optical output of the optical upconverter.

7. The optical transmitter of claim 6, further comprising:
a second feedback circuit responsive to an optical output of the optical upconverter and providing a second feedback signal indicative of power at the optical output of the optical upconverter;
a second variable DC voltage source responsive to the second feedback signal and providing a variable DC voltage bias to the second electrical input, wherein the variable DC voltage source responds to the second feedback signal to reduce the power at the optical output of the optical upconverter.

8. The optical transmitter of claim 7, further comprising:
a third feedback circuit responsive to an output of the optical upconverter and providing a third feedback signal indicative of power at the optical output of the optical upconverter;
a third variable DC voltage source responsive to the third feedback signal and providing a variable DC voltage bias to an electrical phase input to the optical upconverter, wherein the variable DC voltage source responds to the third feedback signal to reduce the power at the optical output of the optical upconverter.

9. The optical transmitter of claim 8, wherein the first, second, and third feedback circuits and the first, second, and third variable DC voltage sources are operate in separate time periods and operate iteratively to adjust DC bias voltages to the first and second electrical inputs and to the phase input so as to minimize the power at the optical output of the optical upconverter during the operation of each of the feedback circuits and variable DC voltage sources.

10. The optical transmitter of claim 9, wherein the DC bias voltages are adjusted to suppress an optical carrier at the optical output of the optical upconverter, and to provide at the optical output of the optical upconverter at least one single sideband optical signal at a frequency other than a frequency of the optical carrier.

11. An optical transmitter, comprising:
an optical carrier source having an optical carrier output;
an optical upconverter having an optical input connected to the output of the optical carrier source, having an optical output, having first and second Mach-Zehnders connected to form a double parallel Mach-Zehnder connected between the optical input and the optical output, wherein the first and second Mach-Zehnders are responsive to signals on first and second electrical inputs, respectively, and having a phase shifter responsive to signals on a phase input and for adjusting relative phase between signals from the first and second Mach-Zehnders;
a photodetector having an optical input and an electrical output, wherein the optical input is optically connected to the optical output of the upconverter,
a first bias circuit having an input connected to the output of the photodetector and having an output connected to the first electrical input, for providing a bias voltage to the first electrical input to reduce power at the optical output during operation of the first bias circuit;
a second bias circuit having an input connected to the output of the photodetector and having an output connected to the second electrical input, for providing a bias voltage to the second electrical input to reduce power at the optical output during operation of the second bias circuit; and
a phase bias circuit having an input connected to the output of the photodetector and having an output connected to the phase input, for providing a bias voltage to the phase input to reduce power at the optical output during operation of the phase bias circuit, wherein the first bias circuit, second bias circuit, and phase bias circuit are operated during separate time periods.

12. The transmitter of claim 11, wherein each of the first and second bias circuits and the phase bias circuit include:
a variable DC voltage source having an input connected to the output of the photodetector, and having an output;
an adder having a first input connected to the output of the variable DC voltage source, a second input, and an output connected to one of the first input, second input, and phase input of the upconverter; and
an electrical oscillator having an output connected to the second input of the adder.

13. The optical transmitter of claim 11, wherein the first bias circuit, second bias circuit, and phase bias circuit are operated in an iterative manner.

14. The optical transmitter of claim 12, wherein the each of the bias circuits include at least one of a filter and an amplifier connected between the photodetector and the variable DC voltage source.

15. The optical transmitter of claim 14, wherein each of the bias circuits include a filter and an amplifier series connected between the photodetector and the variable DC voltage source.

16. The optical transmitter of claim 11, wherein the phase shifter includes:
an electro-optic material in series with at least one optical path in the upconverter; and
input and ground electrodes around the electro-optic material, and wherein the input electrode is connected to the phase input.

17. An optical transmitter, comprising:
an optical carrier source having an optical carrier output;
an optical upconverter having an optical input connected to the output of the optical carrier source, having an optical output, having first and second Mach-Zehnders connected to form a double parallel Mach-Zehnder connected between the optical input and the optical output, wherein the first and second Mach-Zehnders are responsive to signals on first and second electrical inputs, respectively, and having a phase shifter responsive to signals on a phase input and for adjusting relative phase between signals from the first and second Mach-Zehndes;
a photodetector having an optical input and an electrical output, wherein the optical input is optically connected to the optical output of the upconverter,
a first bias circuit having a multiplier with first and second inputs and an output, wherein the first input is connected to the output of the photodetector, a variable DC voltage source having an input connected to the output of the multiplier and having an output, an adder having a first input connected to the output of the variable DC voltage source, having a second input, and having an output connected to the first electrical input of the upconverter, and an electrical oscillator having an output connected to the second input of the adder and connected to the second input of the multiplier;
a second bias circuit having a multiplier with first and second inputs and an output, wherein the first input is connected to the output of the photodetector, a variable DC voltage source having an input connected to the output of the multiplier and having an output, an adder having a first input connected to the output of the variable DC voltage source, having a second input, and having an output connected to the second electrical input of the upconverter, and an electrical oscillator having an output connected to the second input of the adder and connected to the second input of the multiplier;
a phase bias circuit having a multiplier with first and second inputs and an output, wherein the first input is connected to the output of the photodetector, a variable DC voltage source having an input connected to the output of the multiplier and having an output connected to the phase input of the upconverter, and an oscillator connected to the second input of the multiplier.

18. The optical transmitter of claim 17, wherein the first and second bias circuits and the phase bias circuit each include at least one of a filter and an amplifier connected between the multiplier and the variable DC voltage source.

19. The optical transmitter of claim 17, wherein the first and second bias circuits and the phase bias circuit each include a filter and an amplifier series connected between the multiplier and the variable DC voltage source.

20. The optical transmitter of claim 17, wherein the first bias circuit, second bias circuit, and third bias circuit operate simultaneously and iteratively to adjust bias settings in the upconverter.

21. The optical transmitter of claim 17, wherein the phase shifter includes:
an electro-optic material in series with at least one optical path in the upconverter; and
input and ground electrodes around the electro-optic material, and wherein the input electrode is connected to the phase input.
